(19) United States
(12) Patent Application Publication
(10) Pub. No.: US 2006/0024487 A1
(43) Pub. Date: Feb. 2, 2006

(54) Creating stencils using microencapsulated material

(75) Inventors: Nelson A. Blish, Rochester, NY (US); Timothy J. Tredwell, Fairport, NY (US); Lee W. Tutt, Webster, NY (US)

Correspondence Address: Mark G. Bocchetti;Patent Legal Staff, Eastman Kodak Company, 343 State Street, Rochester, NY, 14650-2201, US

(73) Assignee: Eastman Kodak Company

(21) Appl. No.: 10/899,972

(22) Filed: Jul. 27, 2004

(51) Int. Cl. B32B 3/26

(52) U.S. Cl. 428/321.1

(57) ABSTRACT

An apparatus for creating stencils uses microencapsulated material (14) which comprises a printhead (32) for image-wise exposing of the microencapsulated material in a pattern which leaves unexposed an outline of stencil characters (60, 62). A roller ruptures (58) unexposed microcapsules and a chemical in the ruptured microcapsules weakens material outlining the stencil characters (60, 62).

### FIELD OF THE INVENTION

The present invention relates in general to creation of stencils and in particular to creating stencils by imaging microencapsulated material to weaken the borders around the desired stencil characters.

### BACKGROUND OF THE INVENTION

Stencils are useful for making personal items with an individual's name or other identifying information. A problem with making stencils is that they must be either assembled from precut stencil letters and numbers, or the desired message must be cut into the sheet of material to be used for the stencils by a knife or blade. Yet another alternative is stenciling one letter at a time, which is tedious. Both processes are time-consuming and labor intensive. This is especially true for consumers who wish to stencil information on personal items and may only use the stencil one time for one item. An additional problem is that there is no present method for easily creating stencils to make multicolored images.

Photohardenable imaging systems employing microencapsulated radiation sensitive compositions are the subject of U.S. Pat. Nos. 4,399,209; 4,416,966; and 4,440,846. These imaging systems are characterized in that an imaging sheet including a layer of microcapsules containing a photohardenable composition in the internal phase is image-wise exposed to actinic radiation. In the most typical embodiments, the photohardenable composition is a photopolymerizable composition including a polytthylenically unsaturated compound and a photoinitiator and is encapsulated with a color former. Exposure to actinic radiation hardens the internal phase of the microcapsules. Following exposure, the imaging sheet is subjected to a uniform rupturing force by passing the sheet through the nip between a pair of pressure rollers.

### SUMMARY OF THE INVENTION

Briefly, according to the present invention an apparatus for creating stencils uses microencapsulated material and a printhead for image-wise exposing of the microencapsulated material in a pattern which leaves unexposed an outline of stencil characters. A roller ruptures unexposed microcapsules and a chemical in the ruptured microcapsules weakens material outlining the stencil characters.

A printhead, which exposes microcapsules to form images in materials, is adapted for making stencils cheaply and efficiently. In one embodiment of the invention, the letter or numeral to be cut into the stencil is imaged on the microencapsulated material. The microcapsules in the exposed area contain chemicals that weaken the sheet material in the exposed area. The weakened area is then removed to form a stencil.

In another embodiment, a computer is used to form words, numbers, bar codes, or combinations of all of these, and transmit the image pattern to a printhead. The image pattern may be transmitted by computer cable, the Internet, or other electronic means. The printhead forms the image in the microencapsulated material. The exposed material is passed through a set of rollers which ruptures the unexposed microcapsules. Chemicals contained within the unexposed microcapsules weaken the support material so that the characters generated by the computer may be removed from the sheet, thus inexpensively and quickly creating stencils. The stencils could be adapted for home use, ordered from a web site by transmitting the information to be used to create stencils, or ordered at a kiosk.

In the preferred embodiment, the imaged area may be weakened only along the borders of the area to be removed, rather than weakening the entire area of the stencil character. In another embodiment, a series of stencils is formed for each color in a composite image to create a color image stencil. In this embodiment, the computer parses the image into a series of images based on colors present in the image, and generates a series of sub-images, which are then used to generate stencils for each color.

A self-contained imaging assembly comprises a composition comprising photohardenable microcapsules and a degradable polymer material disposed between a first transparent support and a second support, which may be opaque or transparent to form a sealed assembly. The assembly is image-wise exposed to actinic radiation and subjected to an uniform rupturing force to provide stencil character in the composition.

The invention and its objects and advantages will become more apparent in the detailed description of the preferred embodiment presented below.

### BRIEF DESCRIPTION OF THE DRAWINGS

FIG. 1 is a cross-sectional view of an imaging system according to the present invention.

FIG. 2 is a diagrammatical sectional side view of a scanning exposure and pressure applicator apparatus according to one embodiment of the present invention.

FIG. 3 is a plan view of a stencil with a numeral and figure.

FIG. 4 is a schematic view showing creation of a multicolored image using a series of stencils.

FIG. 5 is a schematic view of an inkjet apparatus for creating stencils according to the present invention.

FIG. 6 is a perspective view showing transmission of an image to a remote location for creating a stencil.

### DETAILED DESCRIPTION OF THE INVENTION

The present invention will be directed in particular to elements forming part of, or in cooperation more directly with an apparatus in accordance with the present invention. It is to be understood that elements not specifically shown or described may take various forms well known to those skilled in the art.

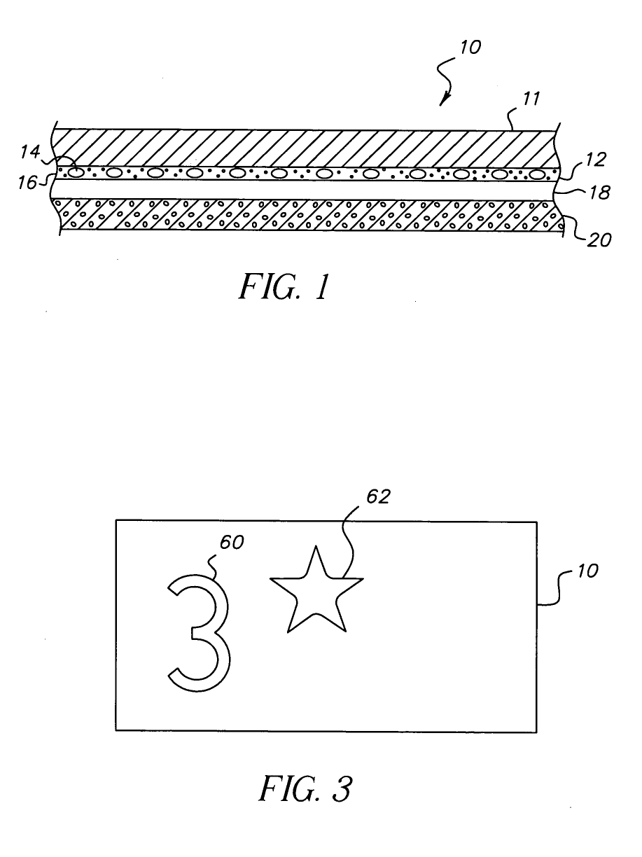

In the self-contained imaging system 10 of the present invention, shown in FIG. 1, a degradable polymer 16 and photohardenable microcapsules 14 are placed in the same imaging layer and the imaging layer is sealed between the two support members 11, 20 to form an integral unit. This sealed format is advantageous because it prevents the degradable polymer material and the chemicals in the microcapsules from contacting persons during handling and, depending on the nature of the supports, it also may prevent oxygen from permeating into the photohardenable material which may improve stability. The term “sealed” as used herein refers to a seal which is designed as a nontemporary seal which results in destruction of the imaging system if the seal is broken.

In the imaging system of the invention, the previously mentioned first support 11 is transparent and the second support 20 may be transparent or opaque. Sometimes herein the first support may be referred to as the “front” support and the second support may be referred to as the “back” support.

In order to insure that the self-contained imaging system 10 is effectively sealed between the supports, a subbing layer (not shown) may be provided between one of the supports and the imaging layer 12 and an adhesive 18 is provided between the other support and the imaging layer. For optical clarity, the subbing layer will typically be located between the first support and the imaging layer. However, which support receives the subbing layer and which support receives the adhesive is a function of which support is coated with the wet imaging layer composition and which support is assembled with the coated and dried imaging layer. The support which is coated with the imaging layer composition (which is typically the front support) will be provided with the subbing layer and the support which is assembled will receive the adhesive. In accordance with the preferred embodiment of the invention, the subbing layer is formed from a compound having chemical moieties such as hydroxy groups which will react with and bind to the microcapsules 14.

One of the most difficult technical hurdles in providing the sealed self-contained assembly of the invention arises from the use of an imaging layer 12 containing both the microcapsules 14 and the material 16 containing a degradable polymer. This format is desirable because the image, in this case the stencil pattern, is formed in direct contact with the front transparent support through which the image is viewed. If the amount of the photoinitiator in the microcapsules is reduced to reduce undesirable background degradation, the film speed of the system is often reduced to such a level that the microcapsules cannot be fully cured without excessively long exposures. In accordance with a particular embodiment of the invention it has been found that an imaging layer containing microcapsules in admixture with the degradable polymer can be provided if the microcapsules contain a disulfide coinitiator as described in U.S. Pat. No. 5,230,982 which is incorporated herein by reference.

Another problem encountered in blending microcapsules 14 and material 16 in a single layer is that the two materials may not be compatible and may agglomerate. If there is an interaction between the degradable polymer and the microcapsules which results in agglomeration, the imaging layer can not be coated with the uniformity and continuity required in a photographic product. The difficulty here is that the microcapsules are prepared from emulsions which incorporate certain system modifiers or emulsifiers and the degradable polymers are also frequently obtained as emulsions which incorporate emulsifiers. If the two emulsifier systems are not compatible with each other, agglomeration results and high photographic quality cannot be obtained. In particular, the applicants have found that it is preferred to encapsulate photohardenable compositions containing acrylates in melamine formaldehyde microcapsules prepared using pectin as the system modifier.

As illustrated in FIG. 1 and in accordance with one embodiment of the present invention, a self-contained imaging system 10 comprises in order: a first transparent support 11, an imaging layer 12 comprising photohardenable microcapsules 14 and a material 16, a layer of adhesive 18, and a second support 20. The first transparent support 11 and second support 20 must be either a weak support, that is having a low cohesive strength, or a degradable polymer. Material 16 is comprised of a degradable polymer and any addenda, such as a base, to prevent acid spread. The addenda can also include inorganic particles to lower the cohesive energy uniformly.

Imaging layer 12 typically contains about 80 to 20% (dry weight) microcapsules and 0 to 20% of a binder. The layer is typically applied in a dry coat weight of about 8 to 20 g/cm.sup.2. An example of such a coating formulation is illustrated below.

In the self-contained photohardenable imaging assembly as shown in FIG. 1, the first transparent support 11 through which the stencil image is formed can be made of any material, limited only by the requirement that the material is of low cohesive strength or degradable with the chemical contained in the microcapsules as will be discussed in more detail below. In one example, the material used in the first transparent support 11 is a polymeric film. The second support 20 is similar. Typically, each of the front and back supports has a thickness of about 1 to 4 mils.

Adhesive materials useful in the adhesive layer 18 in the present invention can be selected from the general class of “modified acrylics” which have good adhesion, and which may be formulated with improved “tack” by addition of tackifying resins or other chemical additives. A useful adhesive must be designed for high initial adhesion and for adhesion to plastic substrates like polyester. It must have the ability to flow quickly for laminating to porous material (the imaging layer) and yet have inertness to the imaging layer. High strength adhesives specifically found useful in this invention are the film label stock adhesives of the 3M Company; preferred are 3M's #300 and #310 adhesive formulas which have shown good “inertness” to the imaging layer and its stability, and are useful when applied in the amount of about 0.5 to 2.0 g/m.sup.2.

Useful photohardenable compositions, photoinitiators, chromogenic materials, carrier oils and encapsulation techniques for the layer of microcapsules 14 are disclosed in U.S. Pat. Nos. 4,440,846 and 5,230,982 which are herein incorporated by reference. Preferred photohardenable compositions are described in U.S. Pat. No. 4,772,541, which is incorporated herein by reference. The aforesaid photohardenable compositions are non-silver systems. Also useful in the present invention is a silver-based photohardenable microencapsulated system such as that described in U.S. Pat. Nos. 4,912,011; 5,091,280 and 5,118,590 and other patents assigned to Fuji Photo Film Co.

In accordance with one embodiment of the invention, a system is provided in which the microcapsules are sensitive to red, green, and blue light respectively. The photohardenable composition in at least one and preferably all three sets of microcapsules is sensitized by a cationic dye-borate anion complex, e.g., a cyanine dye/borate complex as described in U.S. Pat. No. 4,772,541. Yellow, red and green sensitive cyanine borate initiators are examples. Such a material is useful in making contact prints or projected prints of color stencils. They are also useful in electronic imaging using lasers, light emitting diodes, liquid crystal displays or pencil light sources of appropriate wavelengths.

In accordance with a preferred embodiment of the invention, the photohardenable compositions used in the microcapsules contain a dye borate photoinitiator and a disulfide coinitiator. Examples of useful disulfides are described in U.S. Pat. No. 5,230,982 and are compounds of the formula (I) 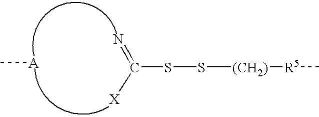
wherein X is selected from the group consisting of S and O except in a specific case in which the disulfide is derived from one or more tetrazolyl groups; n represents 0 or 1; A represents the residue of a ring containing the N, C and X atoms, the ring containing five or six members and, in addition, the ring members may be fused to an aromatic ring; and R.sup.5 is an aromatic radical selected from the group consisting of (i) phenyl, (ii) benzothiazolyl, (iii) benzoxazolyl, (iv) tetrazolyl, (v) pyridinyl, (vi) pyrimidinyl, (vii) thiazolyl, (viii) oxazolyl, (ix) quinazolinyl, and (x) thiadiazolyl, each of which may have a substituent on one or more C or N atoms of the ring. Two of the most preferred disulfides are mercaptobenzothiazo-2-yl disulfide and 6-ethoxymercaptobenzothiazol-2-yl disulfide. By using these disulfides as described in the referenced patent, the amount of the photoinitiators used in the microcapsules can be reduced to levels such that the background coloration or residual stain is less than 0.3 and preferably less than 0.25 density units. At these low levels, the low density image area coloration of the imaging layer does not detract unacceptably from the quality of the image.

The photohardenable compositions of the present invention can be encapsulated in various wall formers using techniques known in the area of carbonless paper including coacervation, interfacial polymerization, polymerization of one or more monomers in an oil, as well as various melting, dispersing, and cooling methods. To achieve maximum sensitivities, it is important that an encapsulation technique be used which provides high quality capsules which are responsive to changes in the internal phase viscosity in terms of their ability to rupture. Because the borate tends to be acid sensitive, encapsulation procedures conducted at higher pH (e.g., greater than about 6) are preferred. Melamine-formaldehyde capsules are particularly useful. It is desirable in the present invention to provide a polyurea pre-wall in the preparation of the microcapsules. U.S. Pat. No. 4,962,010 discloses a particularly preferred encapsulation useful in the present invention in which the microcapsules are formed in the presence of pectin and sulfonated polystyrene as system modifiers. A capsule size should be selected which minimizes light attenuation. The mean diameter of the capsules used in this invention typically ranges from approximately 1 to 25 microns. As a general rule, image resolution improves as the capsule size decreases. Technically, however, the capsules can range in size from one or more microns up to the point where they become visible to the human eye.

Images are formed in the present invention in the same manner as described in U.S. Pat. No. 4,440,846. By image-wise exposing this unit to actinic radiation, the microcapsules are differentially hardened in the exposed areas. The exposed unit is subjected to pressure to rupture the microcapsules.

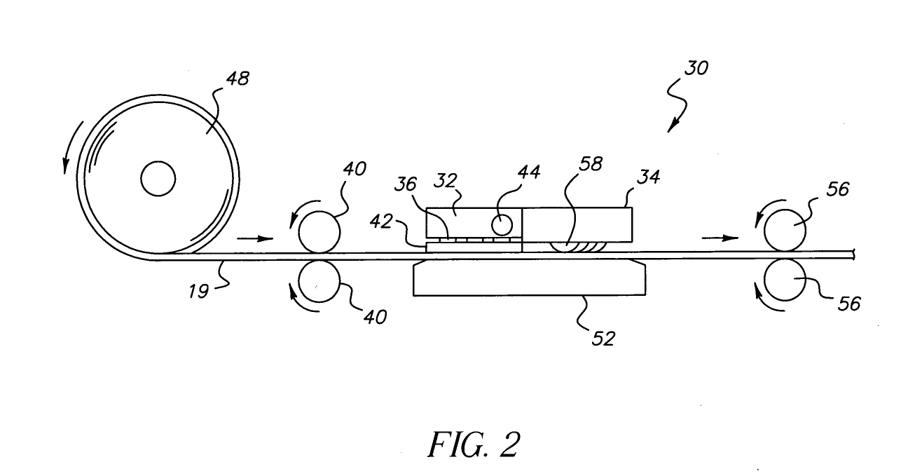

FIG. 2 is a diagrammatic side view of a combined scanning exposure and pressure applicator apparatus 30 containing an exposure head 32, sometimes referred to as a printhead, and a pressure applicator head 34. The pressure applicator apparatus 30 is preferably enclosed in a housing structure (not shown). The exposure head 32 contains a plurality of modulated exposure producing elements 36 which may be in the form of light emitting diodes (LED), liquid crystal display (LCD) panels, lasers, fiber optics, etc. Preferably the exposure producing elements are LEDs mounted in the exposure head 32. The exposure producing elements 36 are activated by energy preferably received from an electronic signal to provide a source of actinic radiation which is directed to an imaging system, shown here as continuous web 19. A beam-forming aperture plate 42 positioned adjacent to the LEDs 36 where the actinic radiation is projected onto the web 19.

The imaging sheet, in the form of a continuous web 19, is typically supplied from a supply roll 48 and transported by feed rollers 40 powered by a motor (not shown) along a longitudinal path in the direction of the arrow to the exposure head 32. The second pair of rollers 56 may or may not be powered by a motor. It is conceivable that the second pair of rollers 56 are powered by a motor and the first set of rollers 40 act as non-powered guide rollers.

As the web 19 passes between the beam-forming aperture plate 42 and support plate 52, a driving system causes the exposure head 32, to oscillate laterally on a carriage rail 44 across the web 19 to form a latent image thereon. After exposure, the web 19 is transported, in one aspect of the invention, the exposed web 19 is passed between the pressure applicator head 34, sometimes referred to as a “roller,” and the support plate 52 to develop the exposed web 19. After the exposed web 19 is developed, the web may be cut transversely using a cutting means (not shown) to provide an individual sheet containing the desired image or stencil. In another aspect of the invention, the exposure head 32 and the pressure applicator head 34 not only oscillate laterally across the imaging media but also traverse through the imaging media in the machine direction longitudinally in a stepwise manner.

The pressure applicator head 34 comprises at least one point contact element 58 and, preferably, a plurality of such point contact elements. The pressure applicator head 34 oscillates laterally across the exposed web 19 so that the point contact elements 58 provide a plurality of overlapping lateral paths across the exposed web 19. The pressure exerted on the exposed web 19 by the point contact elements 58 as they traverse the exposed web 19 causes the unexposed microcapsules to rupture thereby allowing the image-forming material to contact the degradable polymer material and develop the exposed web 19 to form an image thereon. Movement of the advancing web 19 in the machine direction may be continuous or in a stepwise manner and is synchronized with the lateral oscillation of the combined scanning exposure and pressure applicator apparatus 30; or the web 19 may be stationary as indicated above, in which case the exposure head 32 and the pressure applicator head 34 not only oscillate laterally across the imaging media but also traverse the media in the machine direction in a stepwise manner to expose and develop the imaging media. The invention may also be practiced with single sheets rather than a continuous web.

The drive system which causes the exposure head 32 and the pressure applicator head 34 to oscillate across the imaging media may be any device which influences the exposure head 32 and the pressure applicator head 34 to oscillate. Typically, the drive system comprises but is not limited to a continuous motor, a step motor, programmed motors, and the like. The motor which causes the exposure head and the pressure applicator head, or the imaging media, to move in the machine direction may be the same motor which oscillates the exposure head and pressure applicator head laterally or a different motor may be used.

To effect complete diffusion and to activate the chemical contained in the capsules, a post heating step may be desirable. In this case a very simple heated roller may be employed. Other methods include thermal radiation, a thermal head such as is used in thermal dye transfer printers. Any method for heating can be used which is broad area and controllable.

The chemical in the capsule is a material which can cause degradation of the polymer. An acid can be used if it is compatible with the capsule making process. In the event that the method of making the capsules is acid sensitive then an acid precursor is used. This is the preferred embodiment in that the acid precursor is not an acid until it has been heated. Upon heating the acid precursor generates a strong acid which causes the degradation of the degradable polymer.

An acid precursor which can be used in the present invention is discussed below. Specific examples of such acid precursors include the diazonium salts described in S. I. Schlesinger; “Photopolymerization of Epoxides” Society of Photographic Scientists and Engineers, Volume 18, No. 4, July/August 1974, pages 287-393; and T. S. Bal et al.; “Photopolymerization of 1,2-epoxypropane and 1,2-epoxybutane by arenediazonium salts: evidence for anion dependence of the extent of polymerization” Polymer, Volume 21, April 1980, pages 423-428. Other examples are cited in U.S. Pat. No. 5,658,708.

One material which may be used for the degradable polymer is Polyacetal resin, which is sold under the trade name of Duracon. It is also called polyoxymethylene resin or POM resin, and has the chemical structure as shown below.
—(CH₂O)n—

This resin is highly crystalline, tough, and resistant to various chemicals, therefore it is used as a typical engineering plastic in various applications. Although polyacetal resin is highly crystalline, tough, chemically resistant, and superior in friction and wear properties, it is decomposed or degraded under extremely high temperature or in the environment containing acidic components. Furthermore, this decomposition reaction continues successively, once it is started. It is sometimes called unzipping reaction, since it seems as if a zipper were unzipped one tooth by one tooth. Another example of a suitable degradable polymer is polyphthalaldehyde.

In one embodiment of the invention, microcapsules containing an acidic solution are mixed with a degradable polymer. The microcapsules and the degradable polymer are sandwiched between a first and second layer using an adhesive to form a self-contained imaging sheet. The microcapsules are selectively hardened to form an image of a word, number, image, or any combination of these or other characters, which collectively form a “stencil.” The self-contained imaging sheet is passed under a roller or a similar device, which ruptures microcapsules which have not been hardened. The rupture microcapsules release the acid which reacts with the degradable polymer causing the degradable polymer to weaken. In the example shown in FIG. 3 a numeral 60 has been formed in a sheet of self-contained imaging system 10 or “stencil.” A star 62 has also been formed. The degradable polymer may be weakened in an area outlining these figures or the entire interior of the figures may be weakened. In either case, the material is removed from the self-contained imaging system to form the stencil characters. The stencil characters can then be removed from the self-contained imaging sheet 10. The self-contained imaging system is then used to form an image in a typical fashion, such as using spray paint, marker, or other material to apply the stencil to a surface.

Another embodiment uses an acid precursor exactly as in the previous example, followed by passage through a heated roller generating acid where the acid precursor is liberated from the capsules.

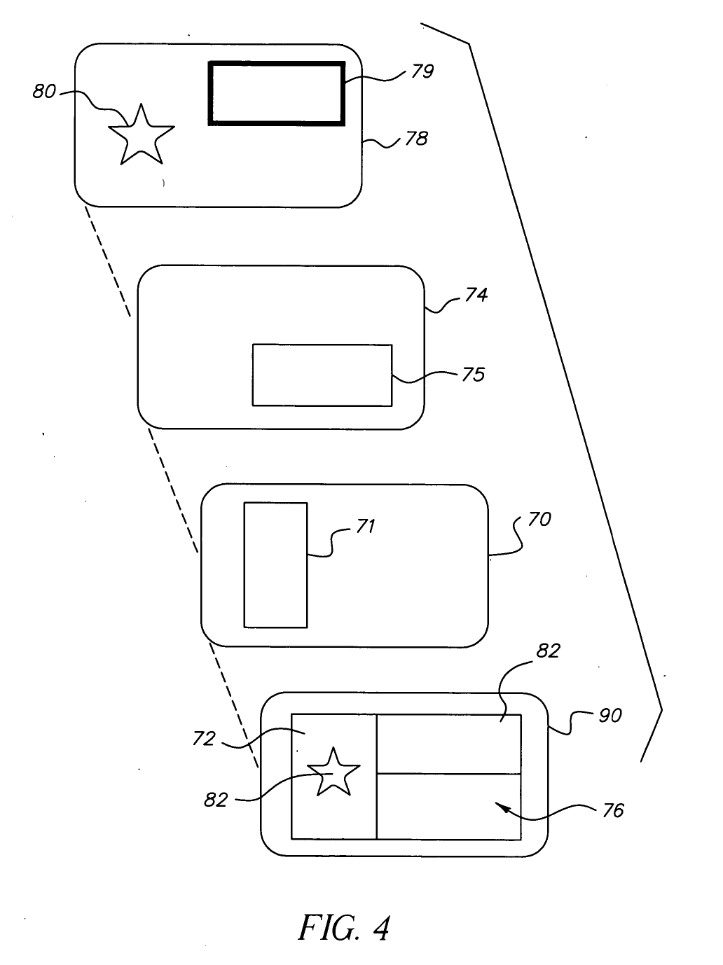

In another embodiment of the invention, shown in FIG. 4, a first self-contained imaging sheet 70 is used to form a first stencil 71, which is used to apply a first color 72, in this case blue, stencil character to a surface 90. A second self-contained imaging sheet 74 is used to form a second stencil 75, which is used to apply a second color 76, in this case red, stencil character to the surface 90. A third self-contained imaging sheet 78 is used to form a third stencil comprising two separate shapes 79 and 80. The third self-contained imaging sheet 78 is used to form a third color 82, in this case white, stencil character on surface 90. In this fashion, a series of stencils is used to build up a color image on the surface 90. Thus, a complex color image can easily be designed and a stencil prepared by a home user for application to flat surfaces or fabric or almost any shape object.

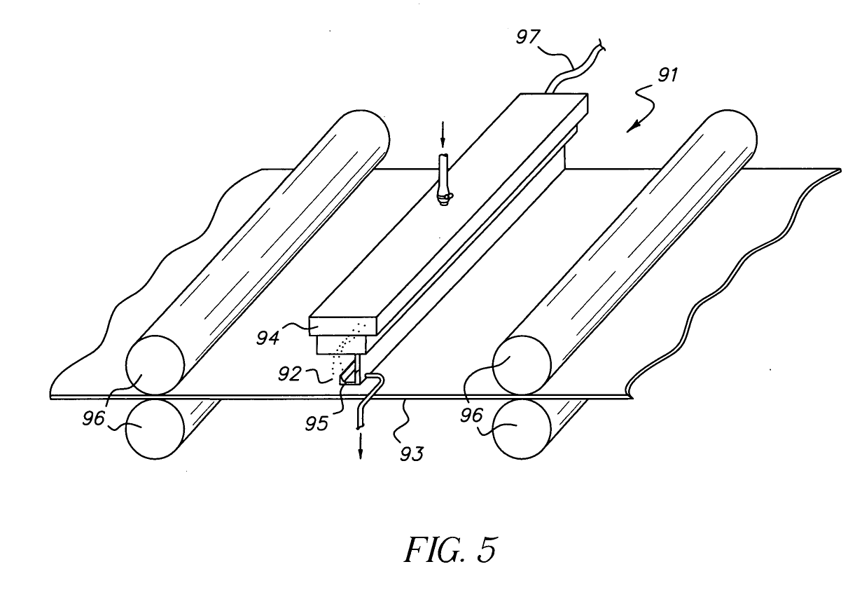

In yet another embodiment of the invention, shown in FIG. 5, imaging material 93 is fed through an inkjet printer 91. In this embodiment the imaging material is comprised of degradable polymer. The inkjet printhead 94 applies material 92, preferably in the form of droplets, which weaken the imaging material 93 in a predetermined pattern. In a preferred embodiment, the material 92 applied is acidic and weakens the imaging material 93. The image pattern is supplied to the inkjet printhead 94 via an Internet cable 97 or other electronic means as is well known in the art. The stencil pattern formed in imaging material 93 are then removed in a manner similar to that discussed above. The inkjet printer shown in this embodiment operates in a continuous manner such that when material is not being applied to form a stencil, it is redirected to trough 95. Transport rollers 96 operate in a fashion which is well known in the art. Although a continuous web with transport rollers is shown, single sheets may be printed as described above. Also, a moving head may be used for application of the material to form the stencils as is well known in the art.

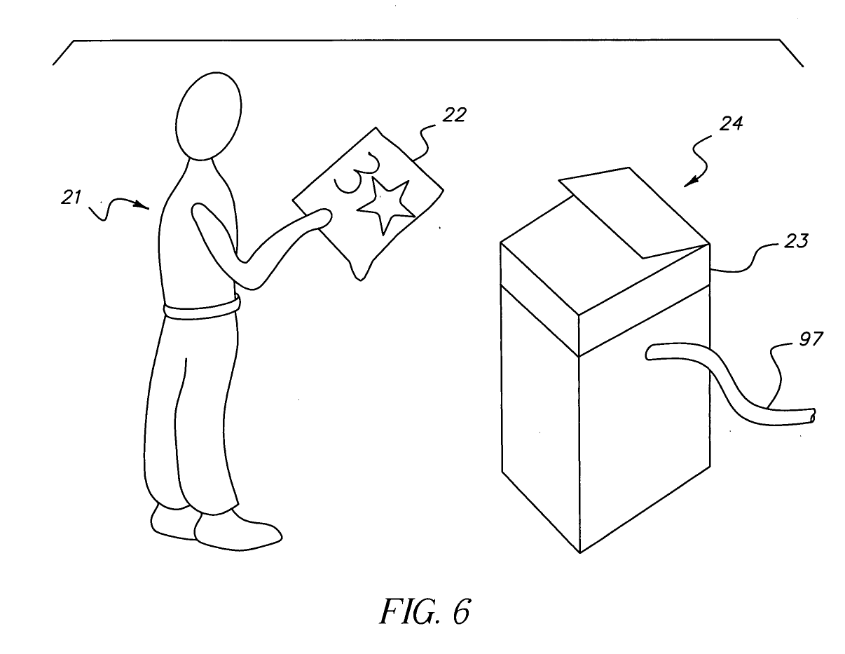

Although the present invention may be practiced at home using an inkjet printer with a specialized cartridge containing an acidic material or acid precursor in combination with a sheet of material comprised of a degradable polymer, the process may be difficult for many home users. In a similar matter, the first embodiment using an LED printhead and sheets containing microencapsulated materials, may be difficult for the average home user to use, especially when applications requiring producing stencils may be utilized in frequency. The invention, therefore, is adaptable for use by transmitting the desired image to a remote location for printing stencils. In the embodiment shown in FIG. 6, an individual 21 desires a stencil from a photograph 22. Although 22 is shown as a photograph containing a numeral and a star-shaped character, it is understood that photograph 22 could easily be an image, slogan, or any combination of letters and numerals generated by a computer or other means and printed on a plain sheet of paper. The individual digitizes the information contained on photograph 22 by means of a scanner 23, which may or may not be contained in a kiosk 24. The information is transmitted by an Internet cable 97 or other electronic means to a remote location for generating stencils, which are then mailed to the individual 21. It is understood that the digital information necessary to produce a stencil may also be transmitted to a remote location by the individual's computer, a flash card inserted into a kiosk, a memory stick inserted into a kiosk, or numerous other means.

The invention has been described in detail with particular reference to certain preferred embodiments thereof, but it will be understood that variations and modifications can be effected within the scope of the invention.

### PARTS LIST

10 self-contained imaging system
11 first transparent support
12 imaging layer
14 microcapsules
16 material
18 layer of adhesive
19 web
20 second support
21 individual
22 photograph
23 scanner
24 kiosk
30 pressure applicator apparatus
32 exposure head (printhead)
34 pressure applicator head
36 exposure producing elements (LEDs)
40 feed rollers
42 aperture plate
44 carriage rail
48 supply roll
52 support plate
56 rollers
58 point contact element (roller)
60 numeral
62 star
70 first self-contained imaging sheet
71 first stencil
72 first color
74 second self-contained imaging sheet
75 second stencil
76 second color
78 third self-contained imaging sheet
79 shape
80 shape
82 third color
90 surface
91 inkjet printer
92 material
93 imaging material
94 inkjet printhead
95 trough
96 transport rollers
97 Internet cable

1. An apparatus for creating stencils using microencapsulated material comprising:
a printhead for image-wise exposing said microencapsulated material in a pattern which leaves unexposed an outline of stencil characters;
a roller which ruptures unexposed microcapsules; and
wherein a chemical in said ruptured microcapsules weakens material outlining said stencil characters.

2. An apparatus as in claim 1 wherein said microencapsulated material is enclosed in a degradable polymer.

3. An apparatus as in claim 1 wherein said microencapsulated material is acidic.

4. A method of creating stencils in a sheet containing microencapsulated material comprising:
exposing said sheet of microencapsulated material in a pattern which leaves an unexposed area outlining stencil characters;
rupturing said unexposed microcapsules to weaken said sheet in said area outlining said stencil characters; and
removing said stencil characters from said sheet.

5. A method as in claim 4 wherein said microencapsulated material is enclosed in a degradable polymer.

6. A method as in claim 4 wherein said microencapsulated material is acidic.

7. A method as in claim 4 wherein said microencapsulated material is acidic precursors.

8. A sheet of microencapsulated material for creating stencils comprising:
a microcapsule containing layer;
a first support layer on a first side of said microcapsule layer;
a second support layer on a second side of said microencapsulated layer opposite said first support layer;
wherein said first support layer is transparent to radiation;
wherein said microencapsuls contain chemicals which weaken said first and second support layer when ruptured; and
wherein said microcapsules become hardened on exposure to radiation.

9. A sheet of microcapsules as in claim 8 wherein said first support layer is a degradable polymer.

10. A sheet of microcapsules as in claim 9 wherein said degradable polymer is an unzip polymer.

11. A sheet of microcapsules as in claim 8 wherein said microencapsulated material is acidic.

12. A method of creating stencils comprising:
(a) exposing a first sheet of microencapsulated material in a first pattern which leaves an area of unexposed microcapsules outlining at least one first stencil character;
rupturing said unexposed microcapsules in said first sheet to weaken said first sheet in said area outlining said first stencil character;
removing said first stencil character from said first sheet;
transferring said first stencil character from said first sheet using a first color;
(b) exposing a second sheet of microencapsulated material in a second pattern which leaves an area of unexposed microcapsules outlining at least one second stencil character;
rupturing said unexposed microcapsules in said second sheet to weaken said second sheet in said area outlining said second stencil character;
removing said second stencil character from said second sheet; and
transferring said second stencil character from said second sheet using a second color.

13. A method of creating stencils comprising:
(a) exposing a first sheet of microencapsulated material in a first pattern which leaves an area of unexposed microcapsules comprising a first stencil character;
rupturing said unexposed microcapsules;
removing said first stencil character;
transferring said first stencil character to a surface using a first color;
(b) exposing a second sheet of microencapsulated material in a second pattern which leaves an area of unexposed microcapsules comprising a second stencil character;
rupturing said unexposed microcapsules;
removing said second stencil character;
transferring said second stencil character to a surface using a second color;
(c) exposing a third sheet of microencapsulated material in a third pattern which leaves an area of unexposed microcapsules comprising a third stencil character;
rupturing said unexposed microcapsules;
removing said third stencil character; and
transferring said third stencil character to a surface using a third color;

14. A method of creating stencils comprising:
providing a sheet of material;
applying a material to said sheet to form a stencil character on said sheet;
wherein said material applied to said sheet weakens said material in the area in which it is applied; and
removing said stencil characters from said sheet.

15. A method as in claim 14 wherein said sheet is degradable polymer.

16. A method as in claim 14 wherein said material is acidic.

17. A method as in claim 14 wherein said material is applied by an inkjet printer.

18. A method as in claim 17 wherein information to form said stencil characters are transmitted to said inkjet printer via the Internet.

19. A method as in claim 17 wherein information to form said stencil characters are transmitted electronically.

20. A method of creating stencils comprising:
providing a sheet of degradable polymer material;
moving an inkjet printhead over said sheet;
applying an inkjet pattern to said sheet to form stencil characters on said sheet;
wherein said material applied to said sheet weakens said material in the area in which it is applied; and
removing said stencil characters from said sheet.

21. A method as in claim 20 wherein said inkjet pattern is formed with droplets of acidic liquid.

22. A method as in claim 20 wherein information to form said stencil characters are transmitted via the Internet.

23. A method as in claim 20 wherein information to form said stencil characters are transmitted electronically.

24. A method of creating stencils comprising:
digitizing an image;
transmitting said digitized image to a printer;
forming stencil characters on a sheet; and
removing said stencil characters from said sheet.

25. A method as in claim 24 wherein a material applied to said sheet weakens said image in an area in which it is applied.

26. A method as in claim 24 wherein said sheet is comprised of a degradable polymer.

27. A method as in claim 25 wherein said material is acidic.

28. A method as in claim 24 wherein said printer is an inkjet printer.

29. A method as in claim 24 wherein said digitized image is transmitted via the Internet.

30. A method as in claim 24 wherein said digitized image is transmitted electronically.

31. A method of creating a self-contained imaging sheet for stencils comprising:
providing a first sheet;
applying an imaging layer to said first sheet;
applying an adhesive layer to a second sheet;
joining said first sheet and said second sheet so that said adhesive layer and said imaging layer are in contact;
wherein said first and second sheets are degradable polymer; and
wherein said imaging layer is comprised of acidic microcapsules.

32. A self-contained imaging sheet for creating stencils comprising:
a first sheet of degradable polymer;
a layer of imaging material comprising acidic microcapsules in contact with said first sheet;
an adhesive layer in contact with said imaging layer; and
a second sheet of degradable polymer in contact with said adhesive layer.

33. A self-contained imaging sheet as in claim 32 comprising a subbing layer between said first sheet and said imaging layer.
